(19) United States
(12) Patent Application Publication
(10) Pub. No.: US 2013/0138239 A1
(43) Pub. Date: May 30, 2013

(54) SEMICONDUCTOR YIELD MANAGEMENT SYSTEM

(71) Applicant: Shanghai Huali Microelectronics Corporation, Shanghai (CN)

(72) Inventors: Hunglin CHEN, Shanghai (CN); Kai WANG, Shanghai (CN); Lujun ZHU, Shanghai (CN); Qiliang NI, Shanghai (CN); Yin LONG, Shanghai (CN); Mingsheng GUO, Shanghai (CN)

(73) Assignee: SHANGHAI HUALI MICROELECTRONICS CORPORATION, Shanghai (CN)

(21) Appl. No.: 13/687,197

(22) Filed: Nov. 28, 2012

(30) Foreign Application Priority Data
Nov. 28, 2011 (CN) 201110384048.3

(51) Int. Cl. G05B 11/01

(52) U.S. Cl. CPC G05B 11/01
USPC 700/121

(57) ABSTRACT

The invention provides a semiconductor yield management system. The system comprises an electronic data collection module and an execution module, the execution module comprises a plurality of execution sub-modules in sequence to perform executions on an object successively, the of the execution sub-modules comprises an execution section and an inspection section; the execution section of the execution sub-module is connected with the inspection section of the preceding execution sub-module except for the first execution sub-module; the inspection section of the execution sub-module is connected with the execution section of the subsequent execution sub-module except for the last execution sub-module; the inspection module of the execution sub-module is connected with the electronic data collection module. According to the semiconductor yield management system, the potential not-good wafers can be recorded, analyzed and distributed to the corresponding execution module, which realizes the risk minimization.

### CROSS-REFERENCE TO RELATED APPLICATION

This application claims the priority benefit of China application serial no. 201110384048.3, filed Nov. 28, 2011. All disclosure of the China application is incorporated herein by reference.

### FIELD OF THE INVENTION

The present invention relates to the field of semiconductor manufacturing technology, and more particularly to a semiconductor yield management system.

### BACKGROUND OF THE INVENTION

The fabrication of the semiconductor integrated circuits involves hundreds of process steps and takes tens of days. During the long fabrication process, the process environment and tools change all the time, and each wafer certainly cannot go through totally identical treatment in the micro point of view. Therefore, how to categorize the wafer after the full flow finished or even in the process is one of the critical issues for semiconductor manufacture.

The conventional semiconductor factories screen out the disqualified wafers by end-of-line e-test. However, the e-test usually picks only partial sites of the wafer and cannot cover all. Potentially some not-good wafers could pass the inspection and be packaged for shipping, which could result in more failures in the subsequent on-board tests and merely is a waste. On the other hand, SPC (Statistical Process Control) is applied to the on-line process to monitor each process step and tool, as well as to terminate the process of the OOS (out of spec) wafers. However, SPC still cannot cover all aspects of the process and the defect accumulations of some OOS wafers could be missed.

The U.S. Pat. No. 6,408,219 “FAB yield enhancement system” discloses a system and method for identifying the sources of wafer defects and using the defect information to control the fabrication process. The U.S. Pat. No. 7,117,057, “yield patrolling system” discloses a system for monitoring yield of a manufacturing line such as an integrated circuit fabrication line. However, the treatment of those not-good wafers or potential wafers is not mentioned in these patents.

### SUMMARY OF THE INVENTION

Accordingly, at least one object of the present invention is to provide a semiconductor yield management which can treat and record the not-good or potential not-good wafers.

To achieve these and other advantages and in accordance with the object of the invention, as embodied and broadly described herein, the invention provides a semiconductor yield management system comprising an electronic data collection module and an execution module, the execution module comprises a plurality of execution sub-modules in sequence to perform executions on an object successively, the execution sub-module comprises an execution section and an inspection section; the execution section of the sub-module is connected with the inspection section of the preceding sub-module except for the first execution sub-module; the inspection section of the execution sub-module is connected with the execution section of the subsequent sub-module except for the last execution sub-module; the inspection module of the sub-module is connected with the electronic data collection module;

the object is executed by the execution section of the execution sub-module in sequence after entering into the execution module; the inspection section of the sub-module transports the object to the execution section of the subsequent execution sub-module after inspecting the execution result from the execution section in the same execution sub-module and obtaining an inspection data; and transmits the inspection data to the electronic data collection module.

In the semiconductor yield management system mentioned above, further comprises an engineering abnormal report module, a material review board module, a potential not-good object recording module and an abnormal treating module, the abnormal treating module comprises an out-of-control action plan sub-module, a scrap determination sub-module, a rework sub-module, a verification sub-module and a release sub-module;

the out-of-control action plan sub-module is connected with the execution section and the inspection section of the execution sub-module respectively, and is connected with the scrap determination sub-module;

the scrap determination sub-module is connected with the engineering abnormal report module, the rework sub-module and the verification sub-module;

the rework sub-module is connected with the verification sub-module;

the release sub-module is connected with the execution section and the inspection section of the execution sub-module, and is connected with the potential not-good object recording module;

the out-of-control action plan sub-module is triggered when an abnormality of the object happens in the execution section or the inspection section; the out-of-control action plan sub-module transmits the data of the object to the material review board module and meanwhile transports the object to the scrap determination sub-module;

the scrap determination sub-module determines whether the object need to be scrapped or not; and transmits the data of the object need to be scrapped to the engineering abnormal report module while transports the object not need to be scrapped to the rework module;

the rework module reworks the object not need to be scrapped and transports the reworked object to the verification sub-module;

the verification sub-module verifies the rework result of the object, transports the object up to spec to the release sub-module while transports the object out of spec to the scrap determination sub-module;

the release sub-module transports the object to the execution section or the inspection section of the execution sub-modules which triggers the out-of-control action plan sub-module, and transmits the data of the object to the potential not-good object recording module.

In the semiconductor yield management system mentioned above, the potential not-good object recording module is divided into multiple independent storage units, the independent storage unit comprises a lot number section for recording the lot number of the object, an object number section for recording the number of the object in the lot number, an event section for recording the event by which the out-of-control action plan sub-module is triggered during the execution or the inspection of the object in one of the execution sub-modules, and a risk weighting section for recording the risk weighting which is indicative of the proportion of the event recorded in the event section and the other abnormality events of the whole execution module.

In the semiconductor yield management system mentioned above, further comprises a final inspection module, the final inspection module is connected with the inspection section of the last execution sub-module and the potential not-good object recording module;

the inspection section of the last execution sub-module transports the completely inspected object to the final inspection module;

the final inspection modules determines whether to sample the object according to a predetermined sampling plan and samples the object need to be sampled; wherein the predetermined sampling plan comprises sampling the objects whose data have been recorded in the potential not-good object recording module.

In the semiconductor yield management system mentioned above, the independent storage unit of the potential not-good object recording module comprises multiple event sections for recording the events by which the out-of-control action plan sub-module is triggered during the executions or the inspections of the same object;

the number of the risk weighting sections is the same as the number of the event sections, the risk weighting section is used for recording the corresponding risk weighting of the event recorded in the event section.

In the semiconductor yield management system mentioned above, the independent storage unit of the potential not-good object recording module further comprises a risk value section and a risk value generating module; the risk value generating module is connected with the event sections, the risk proportion sections and the risk value section in the independent storage unit of the potential not-good object recording module respectively; the risk value generating module obtains the events and the corresponding risk weightings from the event sections and the risk weighting sections and generates a risk value accordingly, and transmits the risk value to the risk value section of the independent storage unit.

In the semiconductor yield management system mentioned above, the object is a wafer.

According to the semiconductor yield management system, the potential not-good wafer can be recorded, analyzed and distributed to the corresponding execution module, which realizes the risk minimization.

### BRIEF DESCRIPTION OF THE DRAWINGS

The semiconductor yield management system in accordance with the present invention will be elucidated by reference to the following embodiments and the accompanying drawings, in which:

FIG. 1 is a schematic diagram of the semiconductor yield management system in an embodiment of the present invention;

FIG. 2 is a schematic diagram of the potential not-good object recording module in an embodiment of the present invention.

### DETAILED DESCRIPTION OF THE EMBODIMENTS

The semiconductor yield management system of the present invention will be described in further details hereinafter with respect to the embodiments and the accompanying drawings.

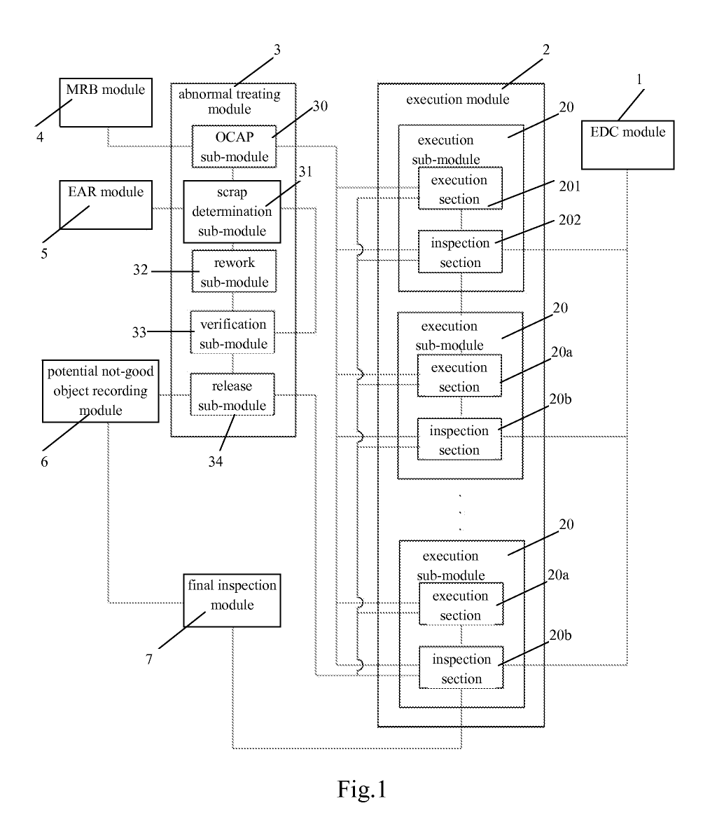

Referring to FIG. 1, the semiconductor yield management system comprises an EDC (electronic data collection) module 1 and an execution module 2. The execution module 2 comprises a plurality of execution sub-modules 20 in sequence to perform executions on an object successively, the execution sub-module 20 comprises an execution section 201 and an inspection section 202; the execution section 201 of the execution sub-module is connected with the inspection section 202 of the preceding execution sub-module except for the first execution sub-module; the inspection section 202 of the execution sub-module is connected with the execution section 201 of the subsequent execution sub-module except for the last execution sub-module; the inspection module 202 of the execution sub-module is connected with the EDC module 1;

the object is executed by the execution sections 201 of the execution sub-modules in sequence after entering into the execution module 20; the inspection section 202 of the execution sub-module transports the object to the execution section 201 of the subsequent execution sub-module after inspecting the execution result from the execution section 201 in the same execution sub-module and obtaining an inspection data; and transmits the inspection data to the EDC module 1.

the semiconductor yield management system further comprises an EAR (engineering abnormal report) module 5, an MRB (material review board) module 4, a potential not-good object recording module 6 and an abnormal treating module 3, wherein the abnormal treating module 3 comprises an OCAP (out-of-control action plan) sub-module 30, a scrap determination sub-module 31, a rework sub-module 32, a verification sub-module 33 and a release sub-module 34;

the OCAP sub-module 30 is connected with the execution section 201 and the inspection section 202 of the execution sub-module respectively, and is connected with the scrap determination sub-module 31;

the scrap determination sub-module 31 is connected with the EAR module 5, the rework sub-module 32 and the verification sub-module 33;

the rework sub-module 32 is connected with the verification sub-module 33;

the release sub-module 34 is connected with the execution section 201 and the inspection section 202 of the execution sub-module, and is connected with the potential not-good object recording module 6;

the OCAP sub-module 31 is triggered when an abnormality of the object happens in the execution section 201 or the inspection section 202 of the execution sub-module; then the triggered OCAP sub-module 31 transmits the data of the object to the MRB module 4 and meanwhile transports the object to the scrap determination sub-module 31;

the scrap determination sub-module 31 determines whether the object need to be scrapped or not; and transmits the data of the object need to be scrapped to the EAR module 5 while transports the object not need to be scrapped to the rework module 32;

the rework module 32 reworks the object not need to be scrapped and transports the reworked object to the verification sub-module 33;

the verification sub-module 33 verifies the rework result of the object, transports the object up to spec to the release sub-module 34 while transports the object out of spec to the scrap determination sub-module 31;

the release sub-module 34 transports the object to the execution section 201 or the inspection section 202 of the execution sub-module which triggers the out-of-control action plan sub-module 30, and transmits the data of the object to the potential not-good object recording module 6.

The semiconductor yield management system further comprises a final inspection module 7, the final inspection module 7 is connected with the inspection section 202 of the last execution sub-module and the potential not-good object recording module 6;

the inspection section 202 of the last execution sub-module transports the completely inspected object to the final inspection module 7;

the final inspection module 7 determines whether to sample the object according to a predetermined sampling plan and samples the object need to be sampled; wherein, according to the predetermined sampling plan, the objects whose data have been recorded in the potential not-good object recording module 6 must be sampled.

In a preferred embodiment, the object is a wafer.

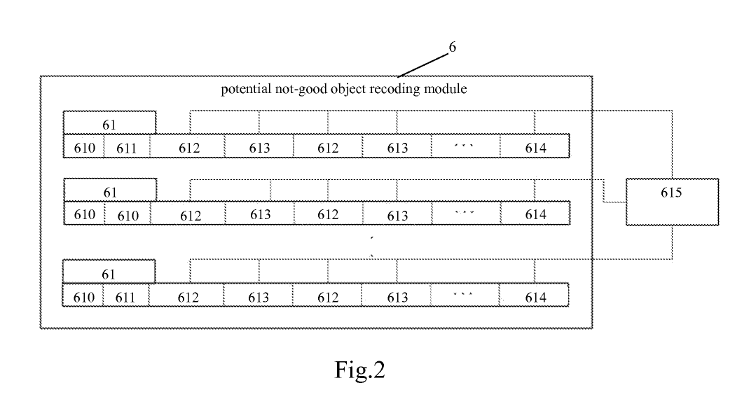

Furthermore, as shown in FIG. 2, the potential not-good object recording module 6 is divided into multiple independent storage units 61, and the independent storage unit 61 comprise a lot number section 610, an object number section 611, an event section 612 and a risk weighting section 613. The lot number section 610 is used for recording the lot number of the object; the object number section 611 is used for recording the number of the object in the lot number; the event section is used for recording the OCAP event by which the OCAP sub-module 31 is triggered during the execution or the inspection of the object in one of the execution sub-modules 20; and the risk weighting section is used for recording the risk weighting, which is indicative of the proportion of the OCAP event and the other abnormality events of the whole execution module.

In some embodiments, the independent storage unit 61 of the potential not-good object recording module comprises multiple event sections 612 for recording multiple OCAP events by which the OCAP sub-module is triggered during the executions or the inspections of the same object;

the number of the risk weighting sections 612 is the same as the number of the event sections 613, the risk weighting section 613 is used for recording the corresponding risk weighting of the OCAP event stored in the event section 612.

The independent storage unit 61 of the potential not-good object recording module further comprises a risk value section 614 and a risk value generating module 615; the risk value generating module 615 is connected with the event sections 612, the risk weighting sections 613 and the risk value section 614 in the independent storage unit of the potential not-good object recording module respectively;

the risk value generating module 615 obtains the OCAP events and the corresponding risk weightings from the event sections 612 and the risk weighting sections 613 and generates a risk value accordingly, then the risk value generating module 615 transmits the risk value to the risk value section 614 of the independent storage unit.

The semiconductor yield management system classifies the abnormal wafers during the semiconductor manufacturing by the abnormal treating module and performs follow-up inspections of the potential not-good wafers, so as to increase the production yield. The semiconductor yield management system combines an execution system for the manufacturing process and a database recording all the on-line abnormalities. When multiple abnormalities happen during the manufacturing of the on-line product and trigger the OCAP sub-module, the system will establish the relations between these single abnormalities and assign a risk weighting to each of the abnormalities according to the influence degree of each abnormality. Once an abnormality happens during a process step for a lot of wafers, the system will calculate the total influence degree, which is generally in the form of a yield percentage, according to the abnormalities of the lot happened in the preceding manufacturing process steps and the risk weightings thereof If the accumulated influence degree reaches the scrapping standard or the shipment ban standard, the subsequent manufacturing process steps of the affected lot will follow the predetermined procedure for disqualified products, and the affected lot will not be shipped with the qualified products. Moreover, the feedback adjustment of the risk weighting according to the final inspection result of the product can continuously optimize the semiconductor yield management system, which is beneficial to concentrate on the OCAP events with larger risk weightings in the on-line manufacturing and improve the defect rate control of the whole plant.

Although the present invention has been disclosed as above with respect to the preferred embodiments, they should not be construed as limitations to the present invention. Various modifications and variations can be made by the ordinary skilled in the art without departing the spirit and scope of the present invention. Therefore, the protection scope of the present invention should be defined by the appended claims.

1. A semiconductor yield management system comprising:
an electronic data collection module and an execution module, the execution module comprises a plurality of execution sub-modules in sequence to perform executions on an object successively, the execution sub-modules comprises an execution section and an inspection section; the execution section of the execution sub-module is connected with the inspection section of the preceding execution sub-module except for the first execution sub-module; the inspection section of the execution sub-module is connected with the execution section of the subsequent execution sub-module except for the last execution sub-module; the inspection module of the execution sub-module is connected with the electronic data collection module;
the object is executed by the execution section of the execution sub-module in sequence after entering into the execution module; the inspection section of the execution sub-module transports the object to the execution section of the subsequent execution sub-module after inspecting the execution result from the execution section in the same execution sub-module and obtaining an inspection data; and transmits the inspection data to the electronic data collection module.

2. The semiconductor yield management system according to claim 1, further comprises an engineering abnormal report module, a material review board module, a potential not-good object recording module and an abnormal treating module, the abnormal treating module comprises an out-of-control action plan sub-module, a scrap determination sub-module, a rework sub-module, a verification sub-module and a release sub-module;
the out-of-control action plan sub-module is connected with the execution section and the inspection section of the execution sub-module respectively, and is connected with the scrap determination sub-module;
the scrap determination sub-module is connected with the engineering abnormal report module, the rework sub-module and the verification sub-module;
the rework sub-module is connected with the verification sub-module;
the release sub-module is connected with the execution section and the inspection section of the execution sub-module, and is connected with the potential not-good object recording module;
the out-of-control action plan sub-module is triggered when an abnormality of the object happens in the execution section or the inspection section; the out-of-control action plan sub-module transmits the data of the object to the material review board module and meanwhile transports the object to the scrap determination sub-module;
the scrap determination sub-module determines whether the object need to be scrapped or not and transmits the data of the object need to be scrapped to the engineering abnormal report module while transports the object not need to be scrapped to the rework module;
the rework module reworks the object not need to be scrapped and transports the object to the verification sub-module;
the verification sub-module verifies the rework result of the object, transports the object up to spec to the release sub-module while transports the object out of spec to the scrap determination sub-module;
the release sub-module transports the object to the execution section or the inspection section of the execution sub-modules which triggers the out-of-control action plan sub-module, and transmits the data of the object to the potential not-good object recording module.

3. The semiconductor yield management system according to claim 2, wherein the potential not-good object recording module is divided into multiple independent storage units, the independent storage unit comprises a lot number section for recording the lot number of the object, an object number section for storing the number of the object in the lot number, an event section for recording the event by which the out-of-control action plan sub-module is triggered during the executions or the inspections of the object in one of the execution sub-modules, and a risk weighting section for recording the risk weighting which is indicative of the proportion of the event recorded in the event section and the other abnormality events of the whole execution module.

4. The semiconductor yield management system according to claim 3, further comprising a final inspection module, the final inspection module is connected with the inspection section of the last execution sub-module and the potential not-good object recording module;
the inspection section of the last execution sub-module transports the completely inspected object to the final inspection module;
the final inspection modules determines whether to sample the object according to a predetermined sampling plan and samples the object need to be sampled; wherein the predetermined sampling plan comprises sampling the objects whose data have been recorded in the potential not-good object recording module.

5. The semiconductor yield management system according to claim 3, wherein the independent storage unit of the potential not-good object recording module comprises multiple event sections for recording the multiple events by which the out-of-control action plan sub-module is triggered during the executions or the inspections of the same object;
the number of the risk weighting sections is the same as the number of the event sections, the risk weighting section is used for recording the corresponding risk weighting of the event recorded in the event section.

6. The semiconductor yield management system according to claim 5, wherein the independent storage unit of the potential not-good object recording module further comprises a risk value section, a risk value generating module; the risk value generating module is connected with the event sections, the risk weighting sections and the risk value section in the independent storage unit of the potential not-good object recording module respectively;
the risk value generating module obtains the events and the corresponding risk weightings from the event sections and the risk weighting sections and generates a risk value accordingly, and transmits the risk value to the risk value section of the independent storage unit.

7. The semiconductor yield management system according to claim 4, wherein the object is a wafer.
